(19) United States
(12) Patent Application Publication
(10) Pub. No.: US 2012/0182212 A1
(43) Pub. Date: Jul. 19, 2012

(54) INPUT DEVICE FOR COMPUTER SYSTEM

(75) Inventors: Tsung-Wen Hsueh, Taipei (TW); Chun-Nan Su, Taipei (TW)

(73) Assignee: PRIMAX ELECTRONICS LTD., Taipei (TW)

(21) Appl. No.: 13/045,343

(22) Filed: Mar. 10, 2011

(30) Foreign Application Priority Data
Jan. 14, 2011 (TW) 100101401

(51) Int. Cl. G09G 5/00

(52) U.S. Cl. 345/156

(57) ABSTRACT

An input device for a computer system includes a command-input unit, a storage unit and a micro-controller unit. The command-input unit is used for generating a control signal. The storage unit is for reading and storing a first data. The micro-controller unit is electrically connected with the command-input unit and the storage unit fore receiving the control signal or the first data and transmitting the control signal or the first data to a computer system according to a Wi-Fi direct protocol, and receiving a second data from the computer system according to the Wi-Fi direct protocol and transmitting the second data to the storage unit.

### FIELD OF THE INVENTION

The present invention relates to an input device, and more particularly to an input device for a computer system.

### BACKGROUND OF THE INVENTION

With increasing development of science and technology, computer systems and the peripheral devices thereof have experienced great growth and are now rapidly gaining in popularity. As known, the input device of the computer host plays an important role in a modern computer system. The common input device includes for example a mouse, a keyboard, a trackball, a presenter, and the like. The mouse is one of the most common input devices because it is very easy to use. When a mouse is held on the palm of a user's hand, the user may move the mouse to control movement of the cursor shown on the computer screen. In addition, by manipulating the buttons of the mouse, the user may point and click a desired icon shown on the computer monitor or execute a corresponding function.

Conventionally, the mouse is connected with a computer host through a connecting wire with a universal serial bus (USB) interface or a PS/2 interface according to a wired transmission technology. Due to the connecting wire, the space utilization of the mouse is restricted. In addition, the connecting wire may become hindrance from operating the mouse. For solving the above drawbacks, a wireless mouse is developed to gradually replace the wired mouse.

FIG. 1 schematically illustrates the connection between a wireless mouse and a computer system according to the prior art. For example, the computer system 1 is a notebook computer. The computer system 1 comprises a monitor 12 for showing a cursor 111 and a graphic-based window 112. The wireless mouse 2 is in communication with the computer system 1 for controlling the cursor 111 to allow the computer host 11 to execute a corresponding command. The wireless mouse 21 comprises a casing 21, a left button 22, a right button 23, a scroll wheel 24 and a storage unit 25. The casing 21 is used for supporting a user's palm. When the casing 21 is moved by the user to result in a displacement amount, the computer host 11 correspondingly moves the cursor 111 shown on the computer monitor 12 according to the displacement amount. By clicking the left button 22 or the right button 23, a control signal is issued to the computer host 21. In response to the control signal, the computer host 11 executes a corresponding command. By rotating the scroll wheel 24, the graphic-based window 112 shown on the computer monitor 12 will be scrolled upwardly or downwardly. Moreover, the storage unit 25 is used for storing various data associated with the computer. In other words, the wireless mouse 2 has the function of a portable hard disc (or USB flash disk).

Generally, the wireless mouse 2 is in communication with the computer host 11 to receive and transmit data according to an infrared transmission technology, a Bluetooth transmission technology or other wireless transmission technology. For wirelessly transmitting data, it is necessary to install a signal receiver 3 at the side of the computer host 11 to receive the signals from the wireless mouse 2. This way of operating the wireless mouse 2 is inconvenient to the user. In addition, the signal receiver 3 may additionally occupy a USB port. For solving the drawbacks, the computer host 11 may be equipped with a Bluetooth transmission module without the need of using the signal receiver 3. However, the use of the wireless mouse 2 still incurs some other drawbacks.

For example, since the wireless mouse 2 with the storage unit 25 can receive data from the computer host 11 and transmit data to the computer host 11, the user usually cares about the speed of data transmission between the computer host 11 and the wireless mouse 2. As known, the data transmission speed implemented by the infrared transmission technology or the Bluetooth transmission technology is very slow. Therefore, there is a need of providing an improved wireless mouse to obviate the drawbacks encountered from the prior art.

### SUMMARY OF THE INVENTION

The present invention relates to an input device for a computer system, and more particularly to provides an input device with an enhanced data transmission speed.

In accordance with an aspect of the present invention, there is provided an input device for a computer system. The input device includes a command-input unit, a storage unit and a micro-controller unit. The command-input unit is used for generating a control signal. The storage unit is for reading and storing a first data. The micro-controller unit is electrically connected with the command-input unit and the storage unit for receiving the control signal or the first data and transmitting the control signal or the first data to a computer system according to a Wi-Fi direct protocol, and receiving a second data from the computer system according to the Wi-Fi direct protocol and transmitting the second data to the storage unit.

In an embodiment, the command-input unit includes a displacement sensor. In response to movement of the command-input unit, the displacement sensor generates the control signal to control a cursor shown on a monitor of the computer system.

In an embodiment, the command-input unit further includes a button unit. When the button unit is clicked, the button unit generates the control signal.

In an embodiment, the storage unit includes a memory and a memory controller. The memory is used for storing the first data. The memory controller is used for reading the first data from the memory and transmitting the first data to the micro-controller unit, and reading the second data from the micro-controller unit and transmitting the second data to the memory for storage.

In an embodiment, the memory is a NAND flash memory.

In an embodiment, the storage unit includes a memory card socket and a memory card controller. The memory card socket is used for accommodating an external memory card, wherein the first data is stored in the external memory card. The memory card controller is used for reading the first data from the external memory card and transmitting the first data to the micro-controller unit, and reading the second data from the micro-controller unit and transmitting the second data to the external memory card for storage.

In an embodiment, the external memory card is a multimedia card (MMC) or a secure digital (SD) card.

In an embodiment, the input device further includes a mode selecting unit, which is electrically connected to the micro-controller unit. By adjusting the mode selecting unit, the input device is operated in one of a first working mode, a second working mode and a second working mode.

In an embodiment, when the input device is operated in the first working mode, the command-input unit is enabled but the storage unit is disabled. When the input device is operated in a second working mode, the command-input unit is disabled but the storage unit is enabled. Whereas, when the input device is operated in a third working mode, the command-input unit and the storage unit are both enabled.

In an embodiment, the mode selecting unit is a mechanical switch or a firmware switch.

In an embodiment, the input device is a mouse or a presenter.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the connection between a wireless mouse and a computer system according to the prior art;

FIG. 2 schematically illustrates the connection between an input device and a computer system according to a first embodiment of the present invention;

FIG. 3A schematically illustrates a first exemplary storage unit used in the input device of the present invention;

FIG. 3B schematically illustrates a second exemplary storage unit used in the input device of the present invention;

FIG. 3C schematically illustrates a third exemplary storage unit used in the input device of the present invention; and

FIG. 4 schematically illustrates the connection between an input device and a computer system according to a second embodiment of the present invention.

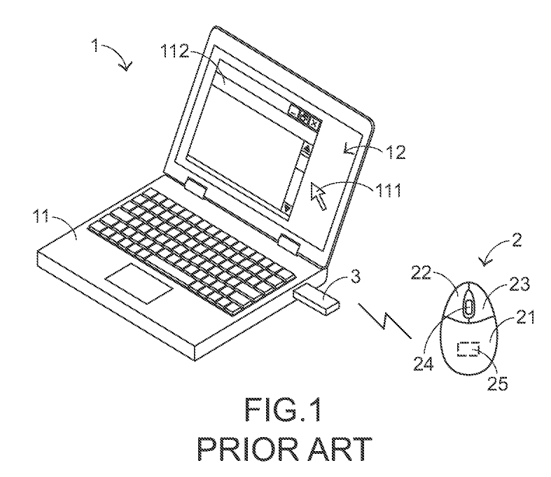

### DETAILED DESCRIPTION OF THE PREFERRED EMBODIMENT

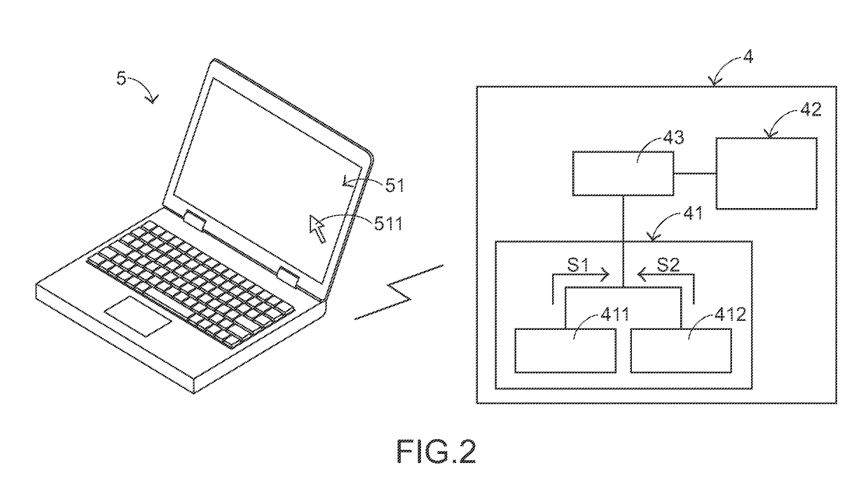

FIG. 2 schematically illustrates the connection between an input device and a computer system according to a first embodiment of the present invention. The user may operate the input device 4 to control the computer system 5. The input device 4 is in communication with the computer system 5 to receive and transmit data according to a wireless communication technology. In this embodiment, the input device 4 comprises a command-input unit 41, a storage unit 42 and a micro-controller unit 43. The micro-controller unit 43 is electrically connected with the command-input unit 41 and the storage unit 42. In this embodiment, the command-input unit 41 is mouse or a presenter.

The command-input unit 41 comprises a displacement sensor 411 and a button unit 412. In response to movement of the command-input unit 41 by the user, the displacement sensor 411 correspondingly issues a first control signal S1 to the micro-controller unit 43. After the first control signal S1 is received by the micro-controller unit 43, the first control signal S1 is transmitted to the computer system 5 through the micro-controller unit 43. According to the first control signal S1, the cursor 511 shown on the monitor 51 of the computer system 5 is controlled. Whereas, when the button unit 412 is clicked, the button unit 412 issues a second control signal S2 to the micro-controller unit 43. After the second control signal S2 is received by the micro-controller unit 43, the second control signal S2 is transmitted to the computer system 5 through the micro-controller unit 43. According to the second control signal S2, the computer system 5 executes a corresponding command.

Moreover, the storage unit 42 is used for reading and storing specified data. The data are storable or readable by the computer system 5. Through the micro-controller unit 43, the data may be exchanged between the storage unit 42 and the computer system 5. That is, a first data originally stored in the storage unit 42 may be transmitted to the computer system 5 through the micro-controller unit 43 and then stored in the computer system 5, or a second data originally stored in the computer system 5 may be transmitted to the storage unit 42 through the micro-controller unit 43 and then stored in the storage unit 42.

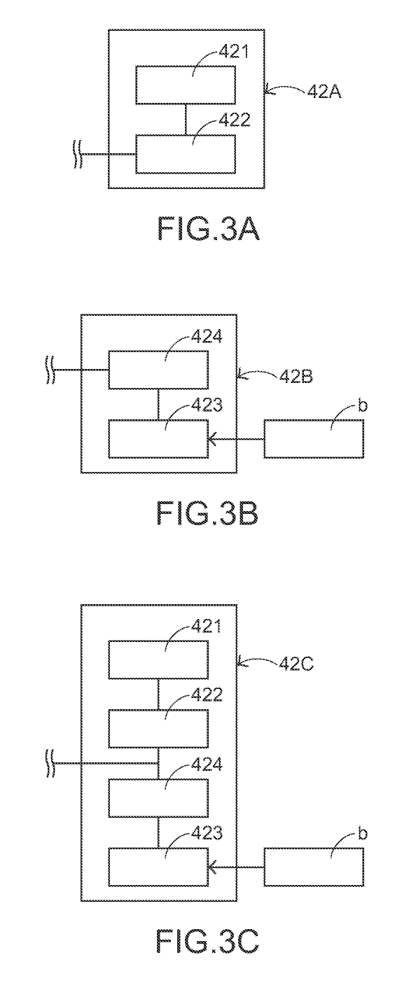

Hereinafter, three examples of the storage unit 42 will be illustrated with reference to FIGS. 3A, 3B and 3C.

FIG. 3A schematically illustrates a first exemplary storage unit used in the input device of the present invention. As shown in FIG. 3A, the storage unit 42A comprises a memory 421 and a memory controller 422. The memory 421 is used for storing data. The memory controller 422 may be used for reading the first data from the memory 421 and transmitting the first data to the micro-controller unit 43. In addition, the memory controller 422 may be used for reading the second data from the micro-controller unit 43, and transmitting the second data to the memory 421 for storage. In an embodiment, the memory 421 is a NAND flash memory.

FIG. 3B schematically illustrates a second exemplary storage unit used in the input device of the present invention. As shown in FIG. 3B, the storage unit 42B comprises a memory card socket 423 and a memory card controller 424. The memory card socket 423 is used for accommodating an external memory card 6. The external memory card 6 is used for storing first data. When the external memory card 6 is inserted into the memory card socket 423, the memory card controller 424 will read the first data from the external memory card 6 and transmit the first data to the micro-controller unit 43. In addition, the memory card controller 424 may be used for reading the second data from the micro-controller unit 43, and transmitting the second data to the external memory card 6 for storage. In an embodiment, the external memory card 6 is a multimedia card (MMC) or a secure digital card (SD).

FIG. 3C schematically illustrates a third exemplary storage unit used in the input device of the present invention. The third exemplary storage unit 42C is a combination of the first exemplary storage unit 42A and the second exemplary storage unit 42B. The storage unit 42C comprises a memory 421, a memory controller 422, a memory card socket 423 and a memory card controller 424. The functions and operations of these components are similar to those of the first exemplary storage unit and the second exemplary storage unit, and are not redundantly described herein.

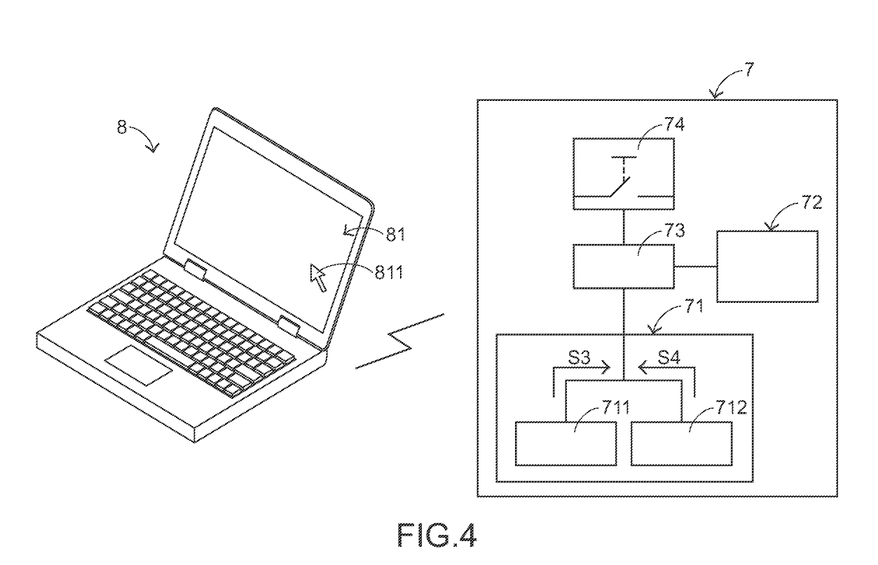

FIG. 4 schematically illustrates the connection between an input device and a computer system according to a second embodiment of the present invention. The architecture of this embodiment is substantially similar to that of the first embodiment. However, the input device 7 may be operated in three working modes. When the input device 7 is operated in a first working mode, the command-input unit 71 is enabled but the storage unit 72 is disabled. When the input device 7 is operated in a second working mode, the command-input unit 71 is disabled but the storage unit 72 is enabled. Whereas, when the input device 7 is operated in a third working mode, the command-input unit 71 and the storage unit 72 are both enabled.

In this embodiment, the input device 7 further comprises a mode selecting unit 74. The mode selecting unit 74 is electrically connected with the micro-controller unit 73. An example of the mode selecting unit 74 includes but is not limited to a mechanical switch or a firmware switch. Through the mode selecting unit 74, a desired working mode may be selected by the user according to the practical requirements. That is, if it is not necessary to simultaneously enable the command-input unit 71 and the storage unit 72, the user may manipulate the mode selecting unit 74 to enable either the command-input unit 71 or the storage unit 72. In such way, the power consumption of the input device 7 is reduced, and thus the time period of using the input device 7 is extended. Moreover, by firmware settings, plural buttons of the button unit 712 are set to have a mode-selecting function so as to define the firmware switch. For example, if the button unit 712 of the input device 7 contains three buttons, by firmware settings, a desired working mode is selected in the condition that the three buttons are simultaneously pressed down.

Hereinafter, the key feature of the present invention will be illustrated with reference to FIG. 4. In accordance with the present invention, the micro-controller unit 73 is in communication with the computer system 8 according to a wireless transmission technology. The first control signal S3 from the displacement sensor 711, the second control signal S4 from the button unit 712 and the first data from the storage unit 72 may be transmitted to the computer system 8 through the micro-controller unit 73 according to a Wi-Fi direct protocol. In addition, the second data from the computer system 8 may be transmitted to the storage unit 72 according to the Wi-Fi direct protocol.

The Wi-Fi direct protocol is a new generation communication protocol, and is also referred as a Wi-Fi Peer-to-Peer protocol. According to the Wi-Fi direct protocol, two Wi-Fi devices can communicate with each other at a high data transmission speed in a Peer-to-Peer manner without the need for wireless access points. By using the Wi-Fi direct protocol to transmit data to replace the infrared or Bluetooth transmission technology, the speed of data transmission between the command-input unit 71 of the input device 7 and the computer system 8 is largely enhanced to comply with the user's requirements. Moreover, since the computer system 8 is equipped with a wireless card supporting the Wi-Fi network, it is not necessary to additionally connect a signal receiver with the computer system. That is, according to the Wi-Fi direct protocol, the input device 7 and the computer system 8 can be in communication with each other to receive and transmit data.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An input device for a computer system, said input device comprising:
a command-input unit for generating a control signal;
a storage unit for reading and storing a first data; and
a micro-controller unit electrically connected with said command-input unit and said storage unit for receiving said control signal or said first data and transmitting said control signal or said first data to a computer system according to a Wi-Fi direct protocol, and receiving a second data from said computer system according to said Wi-Fi direct protocol and transmitting said second data to said storage unit.

2. The input device according to claim 1 wherein said command-input unit comprises a displacement sensor, wherein in response to movement of said command-input unit, said displacement sensor generates said control signal to control a cursor shown on a monitor of said computer system.

3. The input device according to claim 1 wherein said command-input unit comprises a button unit, wherein when said button unit is clicked, said button unit generates said control signal.

4. The input device according to claim 1 wherein said storage unit comprises:
a memory for storing said first data; and
a memory controller for reading said first data from said memory and transmitting said first data to said micro-controller unit, and reading said second data from said micro-controller unit and transmitting said second data to said memory for storage.

5. The input device according to claim 4 wherein said memory is a NAND flash memory.

6. The input device according to claim 1 wherein said storage unit comprises:
a memory card socket for accommodating an external memory card, wherein said first data is stored in said external memory card; and
a memory card controller for reading said first data from the external memory card and transmitting said first data to said micro-controller unit, and reading said second data from said micro-controller unit and transmitting said second data to said external memory card for storage.

7. The input device according to claim 6 wherein said external memory card is a multimedia card (MMC) or a secure digital (SD) card.

8. The input device according to claim 1 further comprising a mode selecting unit, which is electrically connected to said micro-controller unit, wherein by adjusting said mode selecting unit, said input device is operated in one of a first working mode, a second working mode and a second working mode.

9. The input device according to claim 8 wherein when said input device is operated in said first working mode, said command-input unit is enabled but said storage unit is disabled, wherein when said input device is operated in a second working mode, said command-input unit is disabled but said storage unit is enabled, wherein when said input device is operated in a third working mode, said command-input unit and said storage unit are both enabled.

10. The input device according to claim 8 wherein said mode selecting unit is a mechanical switch or a firmware switch.

11. The input device according to claim 1 wherein said input device is a mouse or a presenter.
